(19) United States
(12) Patent Application Publication
(10) Pub. No.: US 2010/0287211 A1
(43) Pub. Date: Nov. 11, 2010

(54) OBJECT LINKING

(75) Inventors: Russell A. BERKOFF, Sunnyvale, CA (US); Alan MESSER, Los Gatos, CA (US)

Correspondence Address: Beyer Law Group LLP/ SISA, P.O. Box 1687, Cupertino, CA, 95015-1687, US

(73) Assignee: SAMSUNG ELECTRONICS CO., LTD., Suwon City (KR)

(21) Appl. No.: 12/463,954

(22) Filed: May 11, 2009

(51) Int. Cl. G06F 17/30

(52) U.S. Cl. 707/803; 707/955; 707/957; 707/812

(57) ABSTRACT

In an embodiment of the present invention, a method for playing media items on a home network device in a home network is provided, the method comprising: retrieving, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and playing the first media item.

### BACKGROUND OF THE INVENTION

1. Field of the Invention

The present invention relates to home networks. More particularly, the present invention relates to the linking of objects for home network data.

2. Description of the Related Art

Universal Plug and Play (UPnP) is a distributed, open networking architecture that allows devices to connect seamlessly and to simplify the implementation of networks in the home (data sharing, communications, and entertainment) and corporate environments. UPnP achieves this by defining and publishing UPnP device control protocols built upon open, Internet-based communication standards.

UPnP has grown in popularity of late in part due to the rise in popularity of media servers. Media servers are self-contained computing devices that store multiple types of content (e.g., photos, music, videos, etc.). The content may then be streamed over the home network from a media server to one or more rendering devices that will play the content. Control points obtain information about content (also known as metadata) and command the media renders to accept content. A control point may be integrated with (contained within) a rendering device such as a network-enabled Digital Television Receiver (DTV), or may be a separate controller which directs a media rendering device to obtain content from a media server.

As an example, a “Media Server” device might contain a significant portion of the homeowner's audio, video, and still-image library. In order for the homeowner to enjoy this content, the homeowner must be able to browse the objects stored on the Media Server, select a specific one, and cause it to be “played” on an appropriate rendering device.

For maximum convenience, it is highly desirable to allow the homeowner to initiate these operations from a variety of User Interface (UI) devices. In most cases, these UI devices will either be a UI built into the rendering device, or a stand-alone UI device such as a wireless PDA or tablet. In other cases, the home network user interface device could be more remote and communicate with the home network through a tunneling mechanism on the Internet.

UPnP publishes metadata describing playback items via the UPnP ContentDirectory service. However, currently the only defined relationship permitted in UPnP is linear playback of items from a list (ordered or unordered). While this is useful for playing of groupings of items, such as songs on an album, it is less helpful when non-linear playback orderings exists. A prime example of a non-linear playback ordering is a DVD playback menu, that permits not only the ordered playing of chapters of the movie, but also allows a user to access related items, such as trailers, director's commentary, alternative scene selections (such as camera angles), making-of documentaries, etc. These features cannot be adequately described using current UPnP Audio/Video (AV) metadata definitions.

### SUMMARY OF THE INVENTION

In a first embodiment of the present invention, a method for playing media items on a home network device in a home network is provided, the method comprising: retrieving, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and playing the first media item.

In a second embodiment of the present invention, a control point in a home network is provided, the control point comprising: a processor configured to: retrieve, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and\play the first media item

In a third embodiment of the present invention, a rendering device in a home network is provided, the rendering device comprising: a processor configured to retrieve, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and play the first media item.

In a fourth embodiment of the present invention, a home network is provided comprising: a content directory service storing a first object, in a series of objects representing a first list in which the first object is a member, wherein the first object contains an attribute defined by a vendor who created the content directory service, wherein the attribute is a text field indicating the relationship between the objects in the first list; a control point having a processor configured to: retrieve, from the content directory service, the first object, wherein the first object contains metadata regarding a first media item, a link to a next object in the first list, and relationship information regarding members of the first list, wherein the next object contains metadata regarding a second media item; and play the first media item.

In a fifth embodiment of the present invention, an apparatus for playing media items on a home network device in a home network is provided, the apparatus comprising: means for retrieving, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and means for playing the first media item.

### BRIEF DESCRIPTION OF THE DRAWINGS

FIG. 1 is a flow diagram illustrating a method for controlling a UPnP control point in accordance with an embodiment of the present invention.

FIG. 2 is a flow diagram illustrating a method for controlling a rendering device in accordance with an embodiment of the present invention.

FIG. 3 is a flow diagram illustrating a method for playing media items on a home network device in a home network in accordance with an embodiment of the present invention.

FIG. 4 is an architecture diagram illustrating a system in accordance with an embodiment of the present invention.

FIG. 5 is an architecture diagram illustrating a system in accordance with another embodiment of the present invention.

FIG. 6 is a diagram illustrating a rendering device in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

It should be noted that the term “home networking” as used throughout this document refers to a type of network that is commonly used in homes to connect media devices. There is no requirement, however, that this type of networking actually be used in homes, as it has equal applicability for use in businesses or other entities. As such, the term “home networking” shall not be construed as limiting any embodiments of the present invention to use in a home, and shall be interpreted as any type of local area network (LAN). For purposes of this document, the term “control point” shall be interpreted to mean any client device in a home network.

In an embodiment of the present invention, new UPnP metadata elements are defined, the new metadata elements defining objects in a generic and reusable manner. These new metadata items then can be used to provide informative metadata describing multiple non-linear orderings of media items.

In order to effectuate these goals, an embodiment of the present invention presents an “objectlink” element in UPnP. The “objectlink” element describes relationships between an object and other objects.

The following example illustrates a metadata structure used to describe the logical relationship between objects. The following objectLink property is used to describe an object which is a member of a list of related objects:

| | |
|---|---|
| <objectLink | groupID=”group-id” |
| | nextObjID=”next-object-id” |
| | headObjID=”head-object-id” > |
| | return=”0\|1”> |

<ObjectLink child elements>
</objectLink>

The following objectList property is used to describe a reference to a list of related objects. This information may be used by the rendering device to offer the end-user one or more sets of related lists of items:

| | |
|---|---|
| <objectList | groupID=”group-id” |
| | newGroupID=”possible-new-group-id” |
| | newObjID=”possible-new-object-id” > |
| | return=”0\|1”> |

<ObjectList child elements>
</objectList>

The objectLink@groupID property indicates how objectLink property elements are “grouped”. Multiple objectLink properties within an object having the same value for their @groupID property should be considered as a single unit when making object-to-object linkage decisions. An empty @groupID property indicates that the objectLink applies to all groups.

The objectLink@nextObjID property indicates the target object that logically follows this object. The target object may be an item or container.

The objectLink@headObjID property indicates the target object at the start of a list of related objects. The <objectLink> property at the start of the list contains child properties describing the contents of the list. The target object may be an item or container.

The objectList@newGroupID property provides the groupID of a new list of related objects.

The objectList@newObjID property provides the target object of a new list of related objects.

Child properties of the objectLink property are used in a number of contexts to convey additional information about a set of related objects.

The objectList property is a reference to a different list of related objects as indicated by the @newObjID and @newGroupID. The child properties of this objectList property provide the title of the related set of objects for the list reference. If these properties are absent, then the properties from the @headObjID of the objectLink list indicated are used.

The objectLink property designated as the first (head) of a list of related objects as indicated by the @headObjID property of the members of this objectLink group. The child properties of this objectLink provide the title of the related set of objects and type information for the list.

An object may have multiple objectLink properties with the same @groupID property. This would indicate that alternate objectLinks containing the indicated groupID value may be taken. Child properties provide a title for each alternate path.

The following objectLink child properties are defined:

The objectLink::title child property provides a displayable title for the set of referred to by this <objectLink> property.

The objectLink::mode child property indicates how the rendering device will handle this list of objects, such as playback (to playback objects in the list), step (to pause after rendering each object in the list), and index (to display the items in the list).

The objectLink::relatedInfo child property provides information about the relationship between the current object and the list of objects indicated in this object link. The property value provides the subject of the relationship.

The objectLink::relatedInfo@role child property provides the type of relationship, including, for example, actor (list objects refer to the indicated actor), scene (list objects relate to a particular scene), and subject (list objects relate to the subject).

Below is an example of UPnP metadata that utilizes the new “objectlink” element in accordance with an embodiment of the present invention.

Initial item which has objectLinks to an entire football game and to highlights:

```
<item id=”start_001” parentID=”xxx” restricted=”1”>
  <dc:title> Superbowl XXVIII</dc:title>
  <upnp:class>object.item.imageItem</upnp:class>
  <objectList groupID=”” newGroupID=”highlights-1”
  newObjID=”highlights_001”>
    <title>Superbowl Highlights</title>
  </objectList>
  <objectList groupID=”” newGroupID=”game-1”
  newObjID=”game_001”>
    <title>Superbowl XIV</title>
  </objectList>
  <objectList groupID=”” newGroupID=”players-1”
  newObjID=”player_001”>
    <title>Dallas Cowboys Team Roster</title>
  </objectList>
  <res protocolInfo=”http-get:*:image/jpeg:*”>http://...</res>
</item>
```

First highlight item which links to second highlight item:

```
<item id=”highlights_001” parentID=”xxx” restricted=”1”>
  <dc:title>Superbowl XXVIII</dc:title>
  <upnp:class>object.item.videoItem</upnp:class>
  <objectLink groupID=”highlights-1” nextObj=”highlights_002”
      headObj=”highlights_001”>
    <title>Superbowl XXVIII Highlights</title>
    <mode>playback</mode>
  </objectLink>
  <res protocolInfo=”http-get:*:video/mpeg:*”>http://...</res>
</item>
<item id=”highlights_002” parentID=”xxx” restricted=”1”>
  <dc:title>Superbowl XXVIII </dc:title>
  <upnp:class>object.item.videoItem</upnp:class>
  <objectLink groupID=”highlights-1” nextObj=””
  headObj=”highlights_001” />
  <res protocolInfo=”http-get:*:video/mpeg:*”>http://...</res>
</item>
```

First player item:

```
<item id=”player_001” parentID=”xxx” restricted=”1”>
  <dc:title>Roger Staubach</dc:title>
  <upnp:class>object.item.imageItem</upnp:class>
  <objectLink  groupID=”players-1”
    <mode>step</type>
    <relatedInfo role=”Subject”>Cowboys Team Roster</relatedInfo>
  </objectLink>
  <res protocolInfo=”http-get:*:image/jpeg:*”>http://...</res>
</item>
```

Item which includes entire game. Continues to make links available to Highlights and Players.

| <item id=”game_001” parentID=”xxx” restricted=”1”> | |
|---|---|
| <dc:title>Superbowl XXVIII</dc:title> | |
| <upnp:class>object.item.videoItem</upnp:class> | |
| <objectLink | groupID=”game-1” |
| | nextObj=”” |
| | headObj=”game_001” |
| | return=”1”> |
| <title>Superbowl XXVIII</title> | |
| <mode>playback</mode> | |
| </objectLink> | |
| <objectList | groupID=”game_001” |
| | newGroupID=”highlights-1” |
| | newObjID=”highlights_001” |
| | return=”1”/> |
| <objectList | groupID=”game_001” |
| | newGroupID=”players-1” |
| | newObjID=”player_001” |
| | return=”1” /> |

<res protocolInfo=”http-get:*:video/mpeg:*”>http://...</res>
</item>

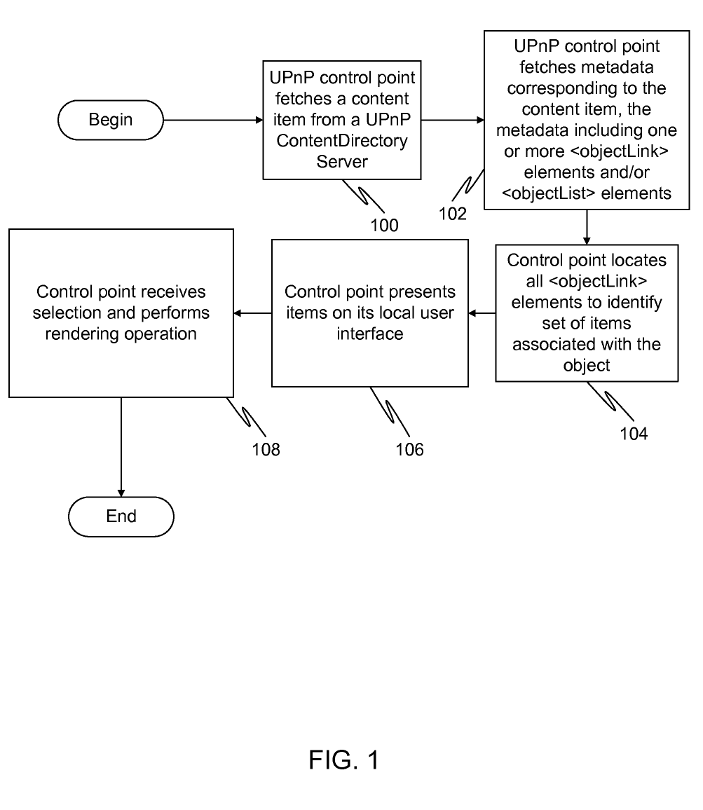

FIG. 1 is a flow diagram illustrating a method for controlling a UPnP control point in accordance with an embodiment of the present invention. In this embodiment, the rendering device is controlled by a separate UPnP control point. At 100, the UPnP control point fetches a content item from a UPnP ContentDirectory Service. At 102, the UPnP control point fetches metadata corresponding to the content item, the metadata including one or more <objectLink> elements and/or <objectList> elements. This may be accomplished via a browse command. At 104, the UPnP control point locates all instances of the new upnp:objectLink property to identify the set of items associated with the object. At 106, the control point examples each item to determine which ones to render. At 108, the control point presents the items on its local user interface. At 108, the control point receives a selection and performs the operation as determined by the control point, such as rendering the base object.

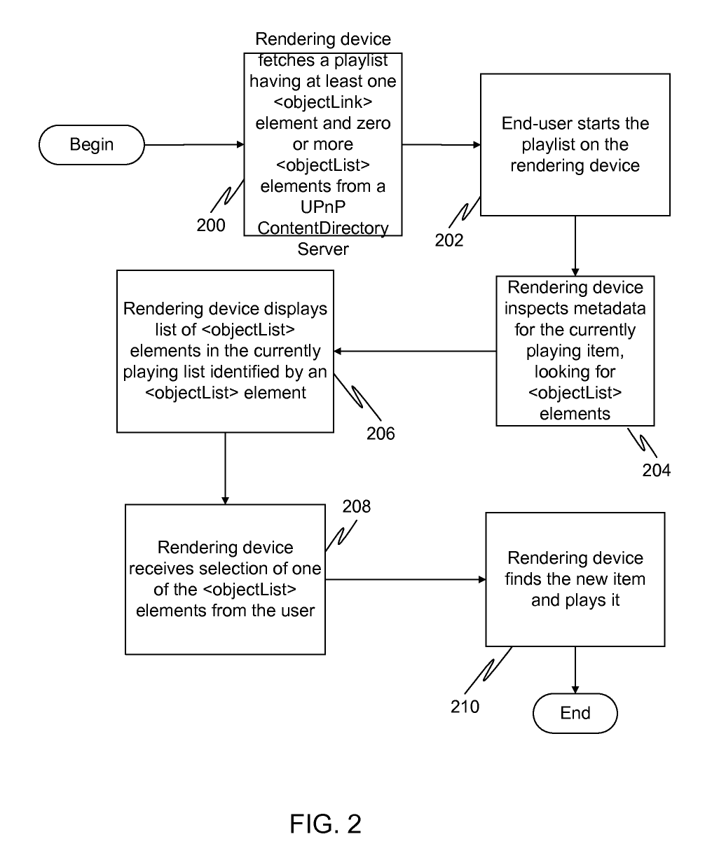

FIG. 2 is a flow diagram illustrating a method for controlling a rendering device in accordance with an embodiment of the present invention. In this embodiment, the rendering device itself accepts playlist items. At 200, the rendering device fetches a playlist from a UPnP ContentDirectory Service. The playlist comprises a series of UPnP metadata items, each of which include at least one <objectLink> element and zero or more <objectList> elements. At 202, the end-user starts the playlist on the rendering device. The playlist may contain a mixture of audio, audio-video, and/or image items. At 204, the rendering device inspects the metadata for the currently playing item, looking for <objectList> elements. At 206, the rendering device displays a list of <objectList> elements in the currently playing list identified by an <objectList> element. At 208, the rendering device receives a selection of one of the <objectList> elements from the user. At 210, the rendering device finds the new media item corresponding to the selected <objectList> element and plays it.

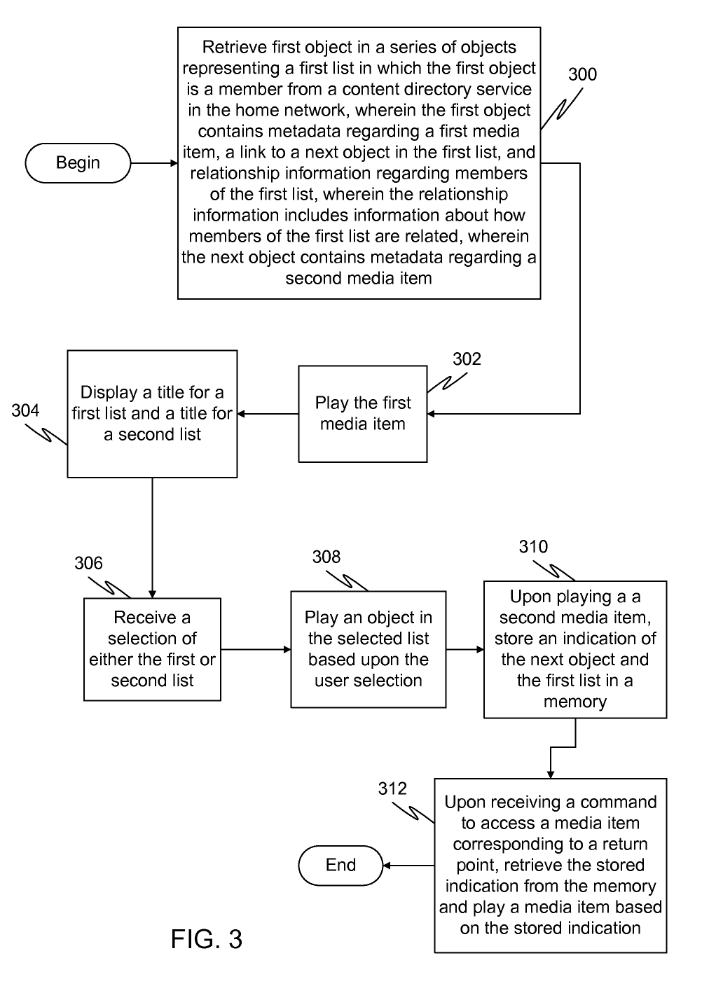

FIG. 3 is a flow diagram illustrating a method for playing media items on a home network device in a home network in accordance with an embodiment of the present invention. The home network may be a UPnP network. At 300, a first object in a series of objects representing a first list in which the first object is a member is retrieved from a content directory service in the home network. The first object contains metadata regarding a first media item, a link to a next object in the first list, and relationship information regarding members of the first list, wherein the relationship information includes information about how members of the first list are related. The series of objects representing a first list are presented in a first order by the content directory service. The next object may actually not be immediately after the first object in the first list according to the first order. Thus the links between objects in the list can vary the order in which the list will be played from the original ordering of the list. At 302, the first media item is played. The next object contains metadata regarding a second media item. The second media item may be a portion of the first media item, such as a highlight or clip, or may be a distinct, but still related, media item, such as a behind-the-scenes video.

The first object may or may not represent the head of the first list. Nevertheless, each object in the first list may contain a link to the head of the list, whether it is the first object or some other object. Each object in the first list may also include a group identifier identifying the first list. This allows the system to easily identify which object link elements constitute a particular list, which is especially helpful where metadata contains more than one object link element list.

The first object also may or may not be a member of more than just the first list. For example, the first object could contain a group identifier identifying a series of objects representing a second list in which the first object is also a member. In such a case, the first object may also contain an indication of whether the first list or the second list should be played first. A title for each of the first and second lists may also then be contained in the first item, and in such cases the method may also include optional steps 304, 306, and 308. In step 304, the title for the first list and the title for the second list are displayed to a user. At 306, a selection of either the first or second list is received, and at 308 an object in the second list is played based upon the user selection. The objects in the selected list may be played according to rules defined for the selected list as identified in a head object of the selected list (which, as described above, may or may not be the first object)

If the first item is the head object in a list, it may contain an indication of how media items in the first list should be played. This may include that the items should be played sequentially without breaks between media items, or that they should be played sequentially with pauses between media items, or that they should first be presented as a table of contents, wherein the table of contents displays each member in the list in textual or iconic format.

A return point capability may also be defined. This capability is depicted as optional steps 310-312. Specifically, the second (next) object may contain a return flag. Then, at 310, upon playing of the second media item, an indication of the second (next) object and the first list may be stored in a memory (such as a stack). At 312, upon receiving a command to access a media item corresponding to a return point, the stored indication may be retrieved from the memory and a media item may be played based on the stored indication. It should be noted that rather then 310 and 312 being performed upon playing of the second media item, an indication of the second object and the first list may be stored in the memory upon selection of the next object by the user.

This return point capability could be used as an alternative to keeping track of or following links within the object link element itself. This would allow a user to quickly and easily go back to the last element accessed, even if that last element is not necessarily the previous object canonically in the list.

It should also be noted that the object link elements may be organized hierarchically, in that, for example, the second metadata may itself also contain a list of additional objectLink elements to which the second metadata is the “head” element. This allows for multi-level organization of objectLink elements.

The inventions described above with respect to FIGS. 1-3 can be implemented on any home network device, including a rendering device or control point. The home network device may contain a processor configured to execute the described steps.

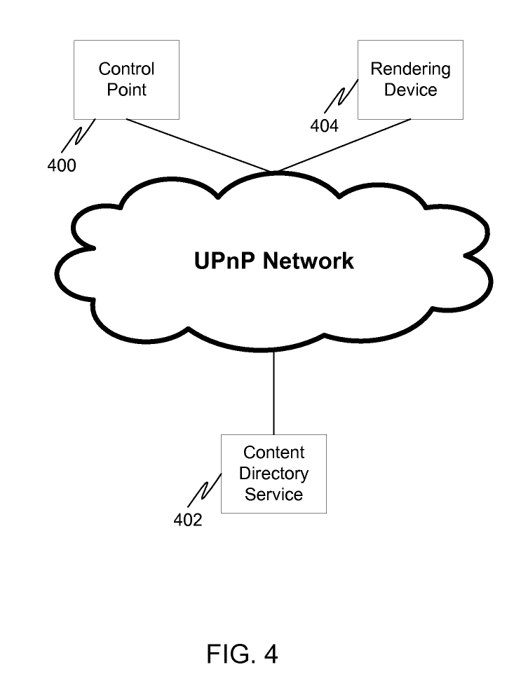

FIG. 4 is an architecture diagram illustrating a system in accordance with an embodiment of the present invention. This figure represents a system wherein the home network device executing the invention is a control point 400, which accesses a content directory service 402 for content and metadata and controls a rendering device 404 to play the appropriate content.

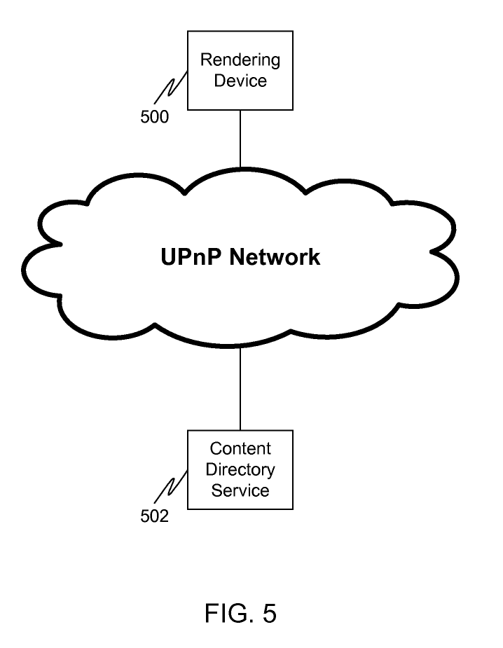

FIG. 5 is an architecture diagram illustrating a system in accordance with another embodiment of the present invention. The figure represents a system wherein the home network device executing the invention is a rendering device 500, which accesses a content directory service 502 for content and plays the appropriate content.

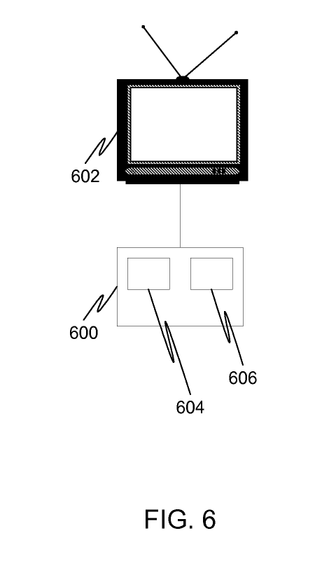

FIG. 6 is a diagram illustrating a rendering device in accordance with an embodiment of the present invention. Here, the rendering device is a set-top box 600 connected to a television 602. The set-top box 600 contains a processor 604 configured to execute the method of FIG. 3 above. The set-top box 600 may also contain a memory such as a stack 606 designed to provide the return point capability described above.

It should be noted that the terms “first” and “second” as used to describe objects and media items throughout this document are intended only to differentiate between different objects and are not meant to imply an ordering of the objects or media items. The ordering of the objects and media items are defined either by the ordering provided by the content directory service or the ordering provided by the links within the objects themselves. In other words, it is possible that the “first” object is, in fact, not the first object in a list.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for playing media items on a home network device in a home network, the method comprising:
retrieving, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and
playing the first media item.

2. The method of claim 1, wherein the series of objects representing a first list are presented in a first order by the content directory service, and wherein the next object is not immediately after the first object in the first list according to the first order, thus allowing for playback of media items corresponding to objects in the first list in a different order than the first order.

3. The method of claim 1, wherein each object in the first list contains a link to the first object, which represents the head of first list.

4. The method of claim 1, wherein each object in the first list includes a group identifier identifying the first list.

5. The method of claim 1, wherein the first object contains a group identifier identifying a series of objects representing a second list in which the first object is also a member.

6. The method of claim 5, wherein the first object contains an indication of whether the first list or the second list should be played first.

7. The method of claim 1, wherein the first object contain an indication of how media items in the first list should be played.

8. The method of claim 7, wherein the indication of how media items in the first list should be played includes the fact that media items in the first list should be played sequentially without breaks between media items.

9. The method of claim 7, wherein the indication of how media items in the first list should be played includes the fact that media items in the first list should be presented as a table of contents, wherein the table of contents displays each member in the list in textual or iconic format.

10. The method of claim 7, wherein the indication of how media items in the first list should be played includes the fact that media items in the first list should be played sequentially with pauses between media items.

11. The method of claim 5, wherein the first object contains a title for the first list and a title for the second list and the method further comprises:
displaying the title for the first list and the title for the second list to a user;
receiving a selection of either the first or second list; and
playing an object in the selected list based upon the user selection.

12. The method of claim 11, wherein the retrieved objects in the selected list based upon the user selection are played according to rules defined for the selected list as identified in a head object of the selected list.

13. The method of claim 8, wherein the second media item is a portion of the first media item.

14. The method of claim 1, wherein the first object further contains a return flag with respect to the next object, and the method further comprises:
upon selection of the next object by a user, storing an indication of the first object and the first list in the memory.

15. The method of claim 11, wherein the first object further contains a return flag, and the method further comprises:
upon receiving a selection of either of the first or second list, storing an indication of the first object and the first list in the memory.

16. The method of claim 14, wherein, upon receiving a command to access a media item corresponding to a return point, retrieving the stored indication from the memory and playing a media item based on the stored indication.

17. The method of claim 15, wherein upon receiving a command to access a media item corresponding to a return point, retrieving the stored indication from the memory and playing a media item based on the stored indication.

18. A control point in a home network, the control point comprising:
a processor configured to:
retrieve, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and
play the first media item.

19. A rendering device in a home network, the rendering device comprising:
a processor configured to:
retrieve, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and
play the first media item.

20. A home network comprising:
a content directory service storing a first object, in a series of objects representing a first list in which the first object is a member, wherein the first object contains an attribute defined by a vendor who created the content directory service, wherein the attribute is a text field indicating the relationship between the objects in the first list;
a control point having a processor configured to:
retrieve, from the content directory service, the first object, wherein the first object contains metadata regarding a first media item, a link to a next object in the first list, and relationship information regarding members of the first list, wherein the next object contains metadata regarding a second media item; and
play the first media item.

21. An apparatus for playing media items on a home network device in a home network, the apparatus comprising:
means for retrieving, from a content directory service in the home network, a first object in a series of objects representing a first list in which the first object is a member, wherein the first object contains metadata regarding a first media item, a link to a next object in the first list, and relationship information regarding members of the first list, wherein the relationship information includes information about how members of the first list are related, wherein the next object contains metadata regarding a second media item; and
means for playing the first media item.
